(19) United States
(12) Patent Application Publication
(10) Pub. No.: US 2026/0323308 A1
(43) Pub. Date: Oct. 15, 2026

(54) METHODS AND MEANS FOR NETWORK AUTONOMOUS HANDLING OF INCREASING TRAFFIC DEMAND

(71) Applicant: Telefonaktiebolaget LM Ericsson (publ), Stockholm (SE)

(72) Inventors: Niklas JALDÉN, Enkoping (SE); Niklas WERNERSSON, Kungsangen (SE); Henrik ASPLUND, Stockholm (SE)

(21) Appl. No.: 19/474,045

(22) PCT Filed: Apr. 12, 2023
(86) PCT No.: PCT/SE2023/050337

§ 371 Date: Oct. 9, 2025

(51) Int. Cl. H04W 16/18; H04W 16/22; H04W 24/08

(52) U.S. Cl. CPC H04W 16/18; H04W 16/22; H04W 24/08

(57) ABSTRACT

A method for a network autonomous handling of an increasing traffic demand in an access network is provided. The method is performed in a device comprises obtaining at least one key performance indicator indicating that performance at one or more entities of the access network is limiting the performance of the access network; retrieving, in response to the indication, information relating to at least one among the one or more entities; processing the retrieved information by estimating a result of adding one or more physical resources in at least one of the one or more entities; and identifying, based on the estimated result, at least one physical resource to be added to the one or more entities, wherein the use of the at least one physical resource prevents or alleviates deterioration of the key performance indicator. A corresponding method, computer program and computer program product are also provided.

### TECHNICAL FIELD

The technology disclosed herein relates generally to the field of communication systems, and in particular to methods and devices for meeting an increasing traffic demand in access networks.

### BACKGROUND

In wireless communication systems there is a demand for higher connection speed for wireless devices and since there is an ever-increasing number thereof a continuous growth of network capacity is required. Studies indicate that, at some point, it will no longer be sufficient to add frequencies, antenna aperture, and/or computational complexity to existing sites to meet the traffic demand. Acquisition of new sites and required infrastructure (electricity, fiber etc.) for these new sites and manual planning is very costly, and many operators therefore want to evolve the existing sites as much as possible before taking steps towards further densification.

An overall coverage and capacity of a system depends on both the hardware used (in Base Station (BS) and in User Equipment (UE)), the available frequency bands as well as environmental characteristics of a cell. For example: in an open area it might be feasible to get a good coverage and throughputs with low transmit (Tx) power, and wide bandwidths at high frequencies owing to favorable propagation conditions, whereas in more cluttered or indoor scenarios users might experience lower throughputs or require higher transmit powers in order to obtain a similar performance. Some of these aspects, such as the hardware and frequency allocations are within the control of an operator, whereas some other, such as the environment (buildings, trees, UE locations etc.) are outside their control.

Through years of simulation expertise, it is well understood that the site-specific aspects of each cell have a large impact on the value that certain products and features may bring to the respective cell. For instance, setting up so-called “digital twins” is valuable as they allow detailed understanding of all aspects required for confident predictions of, for example, “offloading by adding a millimeter wave radio on specific sites” or “introducing feature x in city y”. However, this is a very time-consuming task and requires much manual efforts. Further, the level of details used in simulations often differ from tools used for large scale network planning.

Most currently, planned deployments of 4G and 5G networks utilize so called smart (or advanced) antennas. These antennas allow for spatial signal processing, in turn allowing to adapt transmission in space to adapt to the environment, but also for a much more detailed understanding of the structure of the environment they are deployed in.

From the above, it is realized that network planning involves a costly, time-consuming, and tedious labour. The network planning is often performed with the aid of simulations and the network planning is then never better than the level of details in the models that are used. There is a need for improvements in these regards.

### SUMMARY

An objective of embodiments herein is to address and improve various aspects for network planning. This objective and others are achieved by the methods, devices, computer programs and computer program products according to the appended independent claims, and by the embodiments according to the dependent claims.

According to a first aspect there is presented a method for a network autonomous handling of an increasing traffic demand in communications system. The method is performed in a device and comprises obtaining at least one key performance indicator indicating that performance at one or more entities of an access network is limiting the performance of the access network. In response to the indication, information is retrieved, the information relating to at least one among the one or more entities. The retrieved information is processed by estimating the result of adding one or more physical resources to the at least one of the one or more entities. Based on the estimated result, at least one physical resource to be added to the one or more entities is identified, wherein the use of the at least one physical resource improves at least one key performance indicator.

According to a second aspect, a computer program is provided for handling an increasing traffic demand in an access network. The computer program comprises computer program code, which, when executed in at least one processor of a device causes the device to perform the method according to the first aspect.

According to a third aspect there is presented a computer program product comprising a computer program as above, and a computer readable storage medium on which the computer program is stored.

According to a fourth aspect there is presented a device for a network autonomous handling of an increasing traffic demand in an access network. The device is configured to obtain at least one key performance indicator indicating that performance at one or more entities of the access network is limiting the performance of the access network. The device is configured to retrieve, in response to the indication, information relating to at least one among the one or more entities, and to process the retrieved information by estimating a result of adding one or more physical resources in at least one of the one or more entities. The device is configured to identify, based on the estimated result, at least one physical resource to be added to the one or more entities, wherein the use of the at least one physical resource improves at least one key performance indicator.

Advantageously, these aspects enable an improved way of deciding on how to evolve a communications network in best possible way. The method provides an automated way to guide a network operator and/or a network owner on how to evolve the network most efficiently for it to be able to meet, for instance, an increasing traffic demand and/or increasing quality demand. The method provides a cost-efficient way to accomplish this, as manual labour and corresponding costs are reduced.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise.

The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, wherein:

FIG. 1 illustrates a wireless communication system.

FIG. 2 is a schematic diagram illustrating a flowchart according to embodiments.

FIG. 3 illustrates a respective histogram for two cells.

FIG. 4 illustrates a respective delay spread vs window size for two locations.

FIG. 5 is a flowchart of various embodiments of a method.

FIG. 6 is a schematic diagram showing functional units of a device according to an embodiment.

FIG. 7 is a schematic diagram showing functional modules of a device according to an embodiment.

FIG. 8 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

Briefly, historically the strategy of evolving existing sites is preferred over the acquiring of additional sites. Therefore, adding hardware in the existing sites, i.e., evolving the site, will be a sought-after solution for a foreseeable future. The present teaching addresses this by providing methods and means on how to evolve the existing sites in a most efficient way. Thus, a method and means are disclosed for providing a network operator with specific suggestions on how to evolve a wireless communication system, and in particular access networks thereof, e.g., an existing site, sector, or area thereof, in order to meet an increasing future traffic demand. Various site-specific measurements may, for instance, be initiated and data from these measurements may be analyzed in order to provide such suggestions.

FIG. 1 illustrates an exemplary communication system 10 for wireless communication in which embodiments according to the present teachings may be implemented. The communication system 10 is illustrated in a highly schematical way as comprising several areas, often denoted cells 4a, 4b. These cells 4a, 4b are provided by a base station 2. A radio access network (RAN) 6 connects wireless communication devices 3 to their service provider(s), via wireless communication between a base station 2 near the wireless communication device 3. The communication system 10 further comprises antenna devices 5 by means of which a wireless communication is enabled between the wireless communication devices 3 and the base station 2. All this is well known and is therefore not described in further detail. The various embodiments according to the present teachings may be implemented in such communications system 10, and in particular in entities of the access network 6. Examples of such entities are: base station, evolved Node B (eNB) for Long Term Evolution networks, gNodeB (gNB) for 5G New RAdio networks, base-band unit, radio unit, radio head, Open RAN Distributed Unit (O-DU), and Open RAN Remote Radio Unit (O-RU).

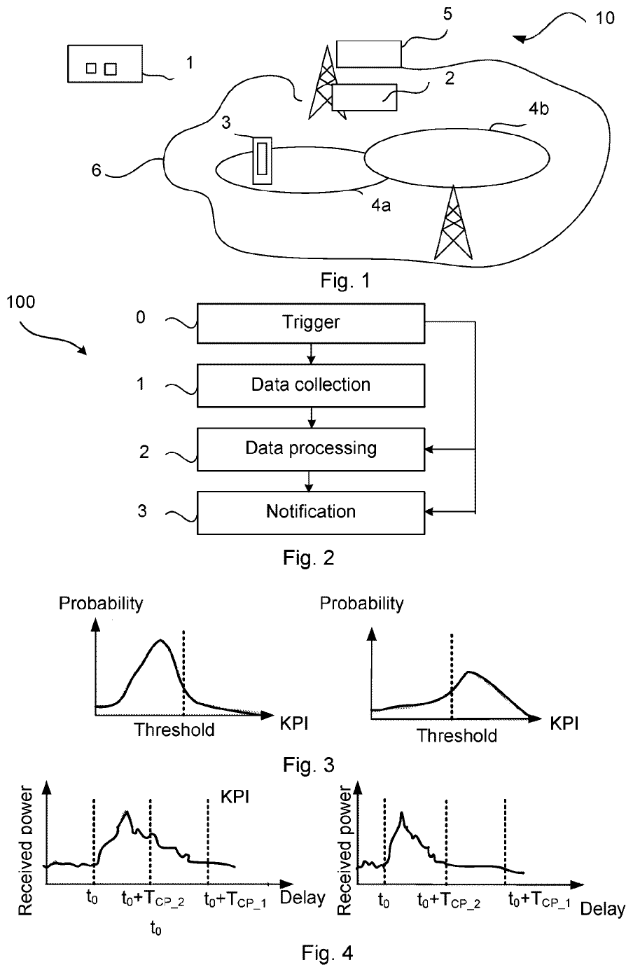

FIG. 2 is a schematic diagram illustrating a basic flowchart of steps of a method according to various embodiments. In FIG. 2 four main blocks are illustrated, and although essentially being depicted as to indicate that steps are to be executed consecutively, it is noted that they may run in any order and could also be run interlaced or in parallel.

A method, in various embodiments, is provided, which method may be carried out for assessing sufficiency of capacity or lack of capacity in a wireless communications network. A trigger may be used for assessing a general need for system upgrades related to the wireless communications network. A step of collecting data and a step of analyzing logs provide an improved space-time understanding of traffic in, for instance, a cell of an access network of the wireless communications network. The data collection and analysis provide a valuable understanding of the implications of potential system upgrades. For instance, a network operator may be given insights such as “an upgrade X will have a very beneficial impact” or “an upgrade Y will have a limited impact” or “option A will have a greater impact than option B”. Such understanding is very valuable and may be used to advice an operator on, for instance, which upgrades that should be prioritized in a system. A notification about potential systems upgrades may be provided. Next, these briefly mentioned steps are described in more detail with reference to FIG. 1.

Box 0 (Trigger): A trigger for use in initiating the method may be implemented in many different ways. The trigger may, for instance, be a device arranged to initiate the method upon obtaining an indication that some parameter is beyond one or more set limits. Such obtaining may e.g., comprise receiving the indication from another entity or by performing comparisons of key values to set threshold values. In other embodiments the trigger performs calculations and/or analysis of a cell, or a network. In other embodiments, the trigger is based on resource utilization at peak hours of a day or over some other period of time. The analysis may comprise a comparison of an average utilization of, for instance, of resources or available spectrum, to a specified threshold or a detection that a time-average is approaching set threshold values or that a trend indicates that threshold values will be exceeded within short, which might indicate that the network is reaching or even going above a specified threshold. In still other embodiments, a Key Performance Indicator (KPI) may be used, such as for example throughput, latency, or number of retransmissions to mention a few examples. The KPI(s) may be analyzed and compared to specified requirement(s).

The analysis may then result in an output from the trigger which relates to the network's (or a given cell's) ability to meet the requirements. The output may be coarse, for instance, a Boolean representing a “able to meet requirements” or “cannot meet requirements”. In other embodiments, a less coarse output may be used, for instance a finite scale ranging from “able to meet requirements with margin” to “cannot meet requirements”. Still finer resolution may also be used, for instance, detailed per User Equipment (UE), information on distributions regarding the analyzed entity or entities (e.g., base station, antenna sector etc.)

It is noted that there may be a certain (e.g., selectable) granularity or multiple types of triggers, each which may initiate a different type or set of measurements. For example, the type of action, and hence measurements needed, may differ if the trigger indicates an increasing number of users having a poor signal-to-noise ratio (SNR) versus if the trigger indicates increased scheduling queuing delay since the former might be solved by exchanging a site antenna for a larger antenna on the same band whereas the second is likely best mitigated by adding more spectrum. Various other actions may also be implemented.

Box 1 (Data collection): A data collection device may be arranged to gather data or statistics of data. The data may, for instance, be related to one or more of: the network's performances, a specific cell's performance, propagations characteristics, sector and antenna beam(s). Next, various specific examples on how to implement the data collection device are given.

In some embodiments data on uplink (UL) reference signals are used. In an embodiment, logs are created that comprise recorded sounding reference signals (SRS) and/or demodulation reference signals (DMRS). These logs of measurements are then used in analyses. Such SRS logs may be large in size and should therefore preferably not be collected continuously, as this would typically require, for instance, too much storage and energy consumption. A two-step procedure may, for instance, be implemented, wherein classical counter logs are created, e.g., 15-minutes aggregated. For simplicity, the case of SRS is given as an example of this, although it is understood that any logs providing similar information may be used. When an SRS log for a UE has been collected, some channel quality and space-time characteristics may be determined for the given UE and its location. Such channel metric determination may be seen as data-compression allowing for statistics on how many users per locations may be gathered. Examples of such metrics are:
Angular power spectrum (may, for instance, be obtained by Fast Fourier Transform (FFT) over antenna port dimension)
Power delay profile (may, for instance, be obtained by Inverse FFT (IFFT) over the frequency response)

These logs are then collected for a period of time for a set of different UEs, sufficient to secure a statistical representation of the current load and distribution of UEs in, for instance, a cell. It is noted that if unlimited storage would be available, raw data could be logged and saved and all calculations could be post-processed. However, since storage capacity will most likely be a limiting factor for a foreseeable future, a two-step approach such as described above is preferred.

In other embodiments, reports from the UE are instead logged or, alternatively, preprocessed and logged. The reports, and the information in these reports, may for instance comprise Channel State Information (CSI)-reports from the UE comprising data, such as e.g., Modulation and Coding Scheme (MCS) and Rank Index (RI), Reference Signal Received Power (RSRP)-reports or Power Headroom Report (PHR).

In still other embodiments, information related to the performance in the network, or cell, is logged. This may, for instance, be information related to latency, throughput, number of retransmissions etc.

In an embodiment all reports received during a time interval and for a set of UEs, are stored. In another embodiment the received reports are instead logged in terms of a histogram. Considering the logging of RSRP reports a histogram may be created representing the percentage of received reports between n*step_size and (n+1)*step_size for a range of values for n. In another embodiment combinations of information are used, e.g., MCS and RI, to estimate one metric that is logged.

In still other embodiments, information related to the performance (performance characteristics) in the network, or cell, is logged. This may, for instance, be information related to latency, throughput, number of retransmissions etc.

Box 2 (Data processing): Once sufficient statistical information has been obtained, evaluation of a few potential network evolutions may be assessed, described below in some exemplifying embodiments. It should be noted that these network evolution steps may correspond to a resource that is currently not available in the cell such as e.g., adding more bands, adding more antennas, or adding more spectrum.

FIG. 3 illustrates a respective histogram for two cells. In one embodiment the KPI RSRP has been logged as a respective histogram for the two cells. Using the knowledge that the logs were collected at, for example 3.5 GHZ, the path loss for each sample is adjusted by a typical path-loss difference between current 3.5 GHZ and the potential new frequency band (e.g., 28 GHz). This is one way to obtain an estimated coverage for a potential new frequency band. This results in a threshold for the RSRP, at 3.5 GHz, that needs to be exceeded in order to expect coverage also at 28 GHZ. As illustrated in the histograms of FIG. 3, it can be noted that for the cell represented by the left histogram, only a small portion of the users in the cell would benefit from the 28 GHz band (the ones in the distribution to the right of the threshold illustrated as a vertical dotted line). For the cell represented by the right histogram, the situation is different, here a large portion of the users would benefit from the 28 GHz band. Hence, given the logged information, together with information of the typical specifications of the 28 GHz product (Tx power, sensitivity etc.), it is possible to conclude that e.g., “60% of the users covered on 3.5 GHZ, in a given cell, could be offloaded to 28 GHz” if such a band were to be added.

In a related embodiment, if the RSRP is determined by using spatial information (such as the SRS) a more detailed evaluation may be performed. Such evaluation may use the actual beamforming gain potential of antenna arrays in order to understand which user directions would be well covered and which directions would not. This may provide further insights on how to mount and/or configure the new equipment in a better way (for instance such that a higher user satisfaction is achieved, a more cost-efficient way etc.).

In further embodiments, the comparison is made also for a set of products on the new band. For example, a logged power angular spectrum could indicate that a total of 60% of users could be covered by antenna type A whereas 70% could be covered by antenna type B, and hence antenna type B could be suggested as a better option.

If a path-loss is known for a certain frequency layer, the path-loss for another frequency may be estimated based thereon. This is known as path-loss shifting between frequency bands and may be performed in different ways. One way is to use average statistics from simulators and ensuring sufficient statistics over similar environments. Another exemplary way is to extract statistics from sites in which two frequency bands are already deployed.

In yet another embodiment the logged data may be used in order to assess the potential gains if upgrading the antenna for the given band. As an example, the logged data may be used to analyze potential gains in upgrading from 4 TX and 4RX antennas, corresponding to a given sector, to a 32 TX and 32 RX antenna.

In another embodiment, the configuration of spatial transmission, e.g., how Synchronization Signal Block (SSB) signals should be beamformed, is included in the notification. This may comprise determining in what directions energy from users in the cell tend to come from and shaping the cell wide SSB transmissions to maximize the energy in these directions while minimizing energy in other directions. Such strategy reduces the interference generated towards users connected to other cells. An example of a user distribution determined from spatial processing of measured SRS transmissions is shown in FIG. 4.

FIG. 4 illustrates a respective delay spread vs window size for two locations. In one embodiment the data logged provides information of the power delay profile (delay spread) of signals. By this information the data processing may evaluate the amount of power (and interference) that would be collected (or experienced) with different numerologies. The (OFDM) numerology describes the physical waveform characteristics, e.g., a sub-carrier spacing and cyclic prefix length, which together determines the symbol time length (3GPP defines different NR numerologies in 3GPP TS 38.211V 17.4.-0). As an exemplifying embodiment, in the leftmost figure the delay spread is such that a majority of signal power is captured within the widow when for numerology (and hence cyclic prefix CP_1), whereas a second numerology would only capture part of the power. In the rightmost figure, the environment is such that the delay spread is short enough to be captured within the cyclic prefix of both numerologies. The delay spread obviously varies within a cell and numerologies should be selected such that a sufficiently large part of the cell has appropriate settings.

Returning now to FIG. 2:

Box 3: Upon completion of the data processing in box 2, a final step may be to notify a requesting part of the results. The notification may comprise advice for a user, operator and/or system about potential system upgrades that are identified as beneficial for improving the problem(s) identified in trigger-box o. In further embodiments, the user, operator and/or system may request a status update for the network upon which information related to the best candidate upgrades in the network is provided.

As still another example, given that the trigger 0 has been triggered, and assuming that the notification 3 outputs “challenging to meet requirements”. However, in the data processing 2 it may have been identified that a set of sites that would benefit from being upgraded. Then the notification 3 may comprise advice to a user, operator or system about potential systems upgrades that have been identified as beneficial. In various embodiments the user, operator or system may request a status update for the network and in response obtain information related to a set of candidate upgrades to be made in the network.

The notification information may be provided through any type of notification, such as a print-out or message in system easily available for an operator. The notification may also be provided to the operator in such a way as to alert her about urgency, e.g., a symbol appearing in an operator monitor or even as an alarm.

In an optional step, and for some cases, the proposed change(s) might be made with the existing equipment on the site, e.g., by changing some operating configuration such as beamforming weights or other operational parameters. The change may then be automatically applied in a controller function.

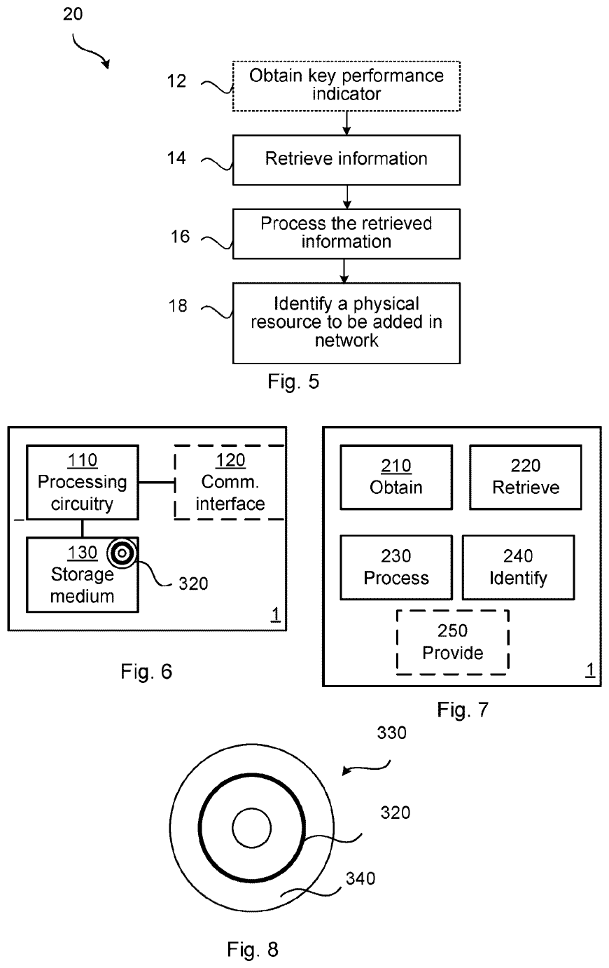

FIG. 5 is a flowchart of various embodiments of a method. The various embodiments and features that have been described may be combined in many different ways, examples of which are given next. The method, described herein in various embodiments, may be implemented in a device 1 such as, for instance, in a processing device, base station, eNB, gNB, base-band unit, radio unit, radio head, O-DU, and O-RU. The device 1 is enabled to obtain and/or receive information from various parts of the communications system 10.

A method 20 is provided for a network autonomous handling of an increasing traffic demand in communications system 10. The method 20 is performed in a device 1 as has been exemplified earlier. The method 20 comprises obtaining 14 at least one key performance indicator that indicates that the performance at one or more entities 2, 3, 5 of the access network 6 is limiting the behaviour or the performance of the access network 6. An example of a limiting behaviour or performance is when the performance of an antenna 2 is a limiting factor in that it is insufficient in providing satisfactory coverage in a cell. Collected logs may reveal this limitation by a performance indicator revealing poor antenna characteristics or lack of spectrum, for which a respective suitable handling may be suggested and/or provided.

The method 20 further comprises retrieving 14, in response to the indication, information relating to at least one among the one or more entities 2, 3, 5.

The method 20 then comprises processing 16 the retrieved information by estimating a result of adding one or more physical resources in at least one of the one or more entities 2, 3, 5. For example, the processing may reveal that adding resource Q would improve capacity by a factor X.

The method 20 comprises identifying 18, based on the estimated result, at least one physical resource to be added to the one or more entities 2, 3, 5, wherein the use of the at least one physical resource improves at least one key performance indicator. There are various KPIs that may be used.

The method 20 provides a number of advantages. For instance, by means of the method 20 an automated method for guiding a network owner or network operator on how to best evolve the network in order to cope with, for instance, an increasing traffic demand. The method decreases required manual work, and costs related thereto, that is currently required for finding the action that needed to develop the network such as to meet the demand. This might, as noted earlier, involve manual work for performing various measurements or setting up measuring equipment etc. The method is a cost-efficient way to improve performance where it is most needed and in a way that gives the best improvement.

In an embodiment, the key performance indicator relates to at least one of: resource utilization during a period of time exceeding a specified threshold; a time-average approaching set threshold values or a trend indicating that threshold values will be exceeded within short; failure to meet the key performance indicator with a required margin. This is just an exemplary set of KPIs that may be used in the method 20.

In various embodiments, the method comprises providing a suggestion on the at least one physical resource to be added by an operator. In another set of embodiments, the method 20 instead comprises the access network 6 autonomously reallocating or adding the at least one physical resource. Which method to use may, for instance, depend on available budget or manpower.

In various embodiments, the identifying 18 the at least one physical resource comprises a physical resource currently not available in the access network 6. For instance, a new or additional resource (e.g., antenna) might be added to increase coverage.

In various embodiments, the processing 16 the obtained information comprises predicting the performance indicator for each of one or more identified physical resources should any of them be added. In such embodiments, data simulations may for instance be used.

In various embodiments, the physical resource that improves the at least one performance indicator comprises one or more of: added frequency band, added antennas, added frequency spectrum, adding processing capabilities. Various other physical resources may also be used.

In various embodiments, the retrieving 14 of information comprises retrieving data or statistics of data collected from one or more of the entities 2, 3, 5. The data comprises one or more of: data on a wireless network of the communications system 10, data on a cell 4a, 4b of the communications system 10, reports from wireless devices 3, recorded signals, uplink reference signals, demodulation reference signals, sounding reference signals, angular power spectrum, power delay profiles. There are thus various ways to obtain data.

In various embodiments, the method comprises providing a notification informing on identified potential access network 6 upgrades.

In various embodiments, the one or more entities 2, 3, 5 of the access network 6 being limiting for the performance of the access network 6 comprises one or both of: a key performance indicator indicating at least one of the entities to be insufficient in meeting the current or a forthcoming traffic demand, a key performance indicator indicating at least one of the entities to have a low performance.

A device 1 is also disclosed, the device 1 being suitable for a network autonomous handling of an increasing traffic demand in a communications network 10. The device 1 may be configured to perform any of the embodiments of the method 20 that has been described.

The device 1 is configured to obtain at least one key performance indicator indicating that performance at one or more entities 2, 3, 5 of the access network 6 is limiting the performance of the access network 6.

The device 1 is configured to retrieve, in response to the indication, information relating to at least one among the one or more entities 2, 3, 5.

The device 1 is configured to process the retrieved information by estimating a result of adding one or more physical resources in at least one of the one or more entities 2, 3,5.

The device 1 is configured to identify, based on the estimated result, at least one physical resource to be added to the one or more entities 2, 3, 5, wherein the use of the at least one physical resource improves at least one key performance indicator.

In an embodiment, the key performance indicator comprises or relates to at least one of: resource utilization during a period of time exceeding a specified threshold; a time-average approaching set threshold values or a trend indicating that threshold values will be exceeded within short; failure to meet the key performance indicator with a required margin.

In different embodiments, the device 1 is configured to provide a suggestion on the at least one physical resource to be added by an operator.

In various embodiments, the device is configured to autonomously reallocate or add the at least one physical resource.

In various embodiments, the device is configured to identify the at least one physical resource by a physical resource currently not being available in the access network 6. In various embodiments, the device is configured to process the obtained information by predicting the performance indicator for each of one or more identified physical resources should any of them be added.

In various embodiments, the device is configured to add a physical resource improving the performance indicator for the at least one physical resource selected among one or more of: added frequency band, added antennas, added frequency spectrum, adding processing capabilities.

In various embodiments, the device is configured to retrieve information by retrieving data or statistics of data collected from one or more of the entities 2, 3, 5, the data comprising one or more of: data on a wireless network of the communications system 10, data on a cell 4a, 4b of the communications system 10, reports from wireless devices 3, recorded signals, uplink reference signals, demodulation reference signals, sounding reference signals, angular power spectrum, power delay profiles.

In various embodiments, the device is configured to provide a notification informing on identified potential access network (6) upgrades.

In various embodiments, the device is configured to determine one or more entities 2, 3, 5 of the access network 6 that are limiting for the performance of the access network 6. Parameters for determining this may, for instance, be found among one or both of: a key performance indicator indicating at least one of the entities to be insufficient in meeting the current or a forthcoming traffic demand, and a key performance indicator indicating at least one of the entities to have a low performance.

FIG. 6 schematically illustrates, in terms of a number of functional units, the components of a device 1 according to an embodiment. Processing circuitry 110 is provided using any combination of one or more of a suitable central processing unit (CPU), multiprocessor, microcontroller, digital signal processor (DSP), etc., capable of executing software instructions stored in a computer program product 330 (as in FIG. 8), e.g., in the form of a storage medium 130. The processing circuitry 110 may further be provided as at least one application specific integrated circuit (ASIC), or field programmable gate array (FPGA).

Particularly, the processing circuitry 110 is configured to cause the device 1 to perform a set of operations, or actions, as disclosed herein. For example, the storage medium 130 may store the set of operations, and the processing circuitry 110 may be configured to retrieve the set of operations from the storage medium 130 to cause the device 1 to perform the set of operations. The set of operations may be provided as a set of executable instructions. The processing circuitry 110 is thereby arranged to execute methods as herein disclosed.

The storage medium 130 may also comprise persistent storage, which, for example, can be any single one or combination of magnetic memory, optical memory, solid state memory or even remotely mounted memory.

The device 1 may further comprise a communications interface 120 for communications with other entities, functions, nodes, and devices, over suitable interfaces. As such the communications interface 120 may comprise one or more transmitters and receivers, comprising analogue and digital components.

The processing circuitry 110 controls the general operation of the device 1 e.g., by sending data and control signals to the communications interface 120 and the storage medium 130, by receiving data and reports from the communications interface 120, and by retrieving data and instructions from the storage medium 130. Other components, as well as the related functionality, of the device 1 are omitted in order not to obscure the concepts presented herein.

FIG. 6 schematically illustrates, in terms of a number of functional modules, the components of a device 1 according to an embodiment. The device 1 of FIG. 6 comprises a number of functional modules; an obtain module 210 configured to obtain at least one key performance indicator indicating that performance of one or more entities of the access network is limiting the performance of the access network; a retrieve module 220 configured to retrieve, in response to the indication, information relating to at least one among the one or more entities; a processing module 230 configured to process the retrieved information by estimating a result of adding one or more physical resources in at least one of the one or more entities; and an identify module 240 configured to identify, based on the estimated result, at least one physical resource to be added to the one or more entities, wherein the use of the at least one physical resource prevents or alleviates deterioration of the key performance indicator. The device 1 of FIG. 6 may further comprise a number of optional functional modules, such as a provide module 250 configured to provide a suggestion on the at least one physical resource to be added by an operator. In general terms, each functional module 210-250 may be implemented in hardware or in software. Preferably, one or more or all functional modules 210-250 may be implemented by the processing circuitry 110, possibly in cooperation with the communications interface 120 and the storage medium 130. The processing circuitry 110 may thus be arranged to from the storage medium 130 fetch instructions as provided by a functional module 210-280 and to execute these instructions, thereby performing any actions of the device 1 as disclosed herein.

FIG. 7 shows one example of a computer program product 330 comprising computer readable means 340. On this computer readable means 340, a computer program 320 can be stored, which computer program 320 can cause the processing circuitry 110 and thereto operatively coupled entities and devices, such as the communications interface 120 and the storage medium 130, to execute methods according to embodiments described herein. The computer program 320 and/or computer program product 330 may thus provide means for performing any actions of the device 1 as herein disclosed.

In the example of FIG. 8, the computer program product 330 is illustrated as an optical disc, such as a compact disc (CD) or a digital versatile disc (DVD) or a Blu-Ray disc. The computer program product 330 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 330.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for a network autonomous handling of an increasing traffic demand in communications system the method being performed in a device and comprising:
obtaining at least one key performance indicator indicating that performance at one or more entities of the access network is limiting the performance of the access network,
retrieving in response to the indication, information relating to at least one among the one or more entities,
processing the retrieved information by estimating a result of adding one or more physical resources in at least one of the one or more entities, and
identifying based on the estimated result, at least one physical resource to be added to the one or more entities, wherein the use of the at least one physical resource improves at least one key performance indicator.

2. The method as claimed in claim 1, wherein the key performance indicator relates to at least one of: resource utilization during a period of time exceeding a specified threshold; a time-average approaching set threshold values or a trend indicating that threshold values will be exceeded within short; failure to meet the key performance indicator with a required margin.

3. The method as claimed in claim 1, comprising providing a suggestion on the at least one physical resource to be added by an operator.

4. The method as claimed in claim 1, comprising the access network autonomously reallocating or adding the at least one physical resource.

5. The method as claimed in claim 1, wherein the identifying the at least one physical resource comprises a physical resource currently not available in the access network.

6. The method as claimed in claim 1, wherein the processing the obtained information comprises predicting the performance indicator for each of one or more identified physical resources should any of them be added.

7. The method as claimed in claim 1, wherein the physical resource improving the at least one performance indicator comprises one or more of: added frequency band, added antennas, added frequency spectrum, adding processing capabilities.

8. The method as claimed in claim 1, wherein the retrieving of information comprises retrieving data or statistics of data collected from one or more of the entities, the data comprising one or more of: data on a wireless network of the communications system, data on a cell of the communications system reports from wireless devices, recorded signals, uplink reference signals, demodulation reference signals, sounding reference signals, angular power spectrum, power delay profiles.

9. The method as claimed in claim 1, comprising providing a notification informing on identified potential access network upgrades.

10. The method as claimed in claim 1, wherein the one or more entities of the access network being limiting for the performance of the access network comprises one or both of: a key performance indicator indicating at least one of the entities to be insufficient in meeting the current or a forthcoming traffic demand, a key performance indicator indicating at least one of the entities to have a low performance.

11. A computer program for handling an increasing traffic demand in a communications system, the computer program comprising computer program code, which, when executed in at least one processor of the device causes the device to perform the method according to claim 1.

12. A computer program product comprising a computer program as claimed in claim 11 and a computer readable means on which the computer program is stored.

13. A device for a network autonomous handling of an increasing traffic demand in a communications network, the device being configured to:
obtain at least one key performance indicator indicating that performance at one or more entities of the access network is limiting the performance of the access network,
retrieve, in response to the indication, information relating to at least one among the one or more entities,
process the retrieved information by estimating a result of adding one or more physical resources in at least one of the one or more entities, and
identify, based on the estimated result, at least one physical resource to be added to the one or more entities, wherein the use of the at least one physical resource improves at least one key performance indicator.

14. The device as claimed in claim 13, wherein the key performance indicator relates to at least one of: resource utilization during a period of time exceeding a specified threshold; a time-average approaching set threshold values or a trend indicating that threshold values will be exceeded within short; failure to meet the key performance indicator with a required margin.

15. The device as claimed in claim 13, configured to provide a suggestion on the at least one physical resource to be added by an operator.

16. The device as claimed in claim 13, configured to instruct the access network to autonomously reallocate or add the at least one physical resource.

17. The device as claimed in claim 13, configured to identify the at least one physical resource by a physical resource currently not being available in the access network.

18. The device as claimed in claim 13, configured to process the obtained information by predicting the performance indicator for each of one or more identified physical resources should any of them be added.

19. The device as claimed in claim 13, configured to select the physical resource improving the performance indicator for the at least one physical resource among one or more of: added frequency band, added antennas, added frequency spectrum, adding processing capabilities.

20. The device as claimed in claim 13, configured to retrieve information by retrieving data or statistics of data collected from one or more of the entities, the data comprising one or more of: data on a wireless network of the communications system, data on a cell of the communications system, reports from wireless devices, recorded signals, uplink reference signals, demodulation reference signals, sounding reference signals, angular power spectrum, power delay profiles.

21-22. (canceled)
